(19) United States
(12) Patent Application Publication
(10) Pub. No.: US 2010/0013615 A1
(43) Pub. Date: Jan. 21, 2010

(54) Obstacle detection having enhanced classification

(75) Inventors: Martial Hebert, Pittsburgh, PA (US); Herman Herman, Pittsburgh, PA (US); Cristian Sergiu Dima, Pittsburgh, PA (US); Anthony Joseph Stentz, Pittsburgh, PA (US)

Correspondence Address: Thorp Reed & Armstrong;One Oxford Centre, 301 Grant Street, PITTSBURGH, PA, 15219-1425, US

(73) Assignee: Carnegie Mellon University, Pittsburgh, PA (US)

(21) Appl. No.: 11/096,687

(22) Filed: Mar. 31, 2005

Related U.S. Application Data
(60) Provisional application No. 60/558,237, filed on Mar. 31, 2004.

(51) Int. Cl. B60Q 1/00

(52) U.S. Cl. 340/425.5

(57) ABSTRACT

A method and system for sensing an obstacle comprises transmitting an electromagnetic signal from a mobile machine to an object. A reflected electromagnetic signal is received from the object to determine a distance between the object and the mobile machine. An image patch is extracted from a region associated with the object. Each image patch comprises coordinates (e.g., three dimensional coordinates) associated with corresponding image data (e.g., pixels). If an object is present, image data may include at least one of object density data and object color data. Object density data is determined based on a statistical measure of variation associated with the image patch. Object color data based on the color of the object detected with brightness normalization. An object is classified or identified based on the determined object density and determined object color data.

### CROSS-REFERENCE TO RELATED APPLICATIONS

The present invention claims priority from U.S. Provisional patent application Ser. No. 60/558,237, filed Mar. 31, 2004, and which is incorporated herein by reference.

### STATEMENT REGARDING FEDERALLY SPONSORED RESEARCH AND DEVELOPMENT

Not Applicable.

### FIELD OF THE INVENTION

The invention relates to obstacle detection and classifying detected obstacles around or in a potential path of a vehicle, machine or robot.

### BACKGROUND OF THE INVENTION

Vehicles, machines and robots may be configured for manned or unmanned operation. In the case of a manned vehicle, an obstacle detector may warn a human operator to take evasive action to avoid a collision with an object in the path of the vehicle. In the case of an unmanned or autonomous vehicle, an obstacle detector may send a control signal to a vehicular controller to avoid a collision or a safety hazard.

Many prior art obstacle detectors cannot distinguish one type of obstacle from another. For example, a prior art obstacle detector may have difficulty in treating high vegetation or weeds in the path of the vehicle differently than an animal in the path of the vehicle. In the former scenario, the vehicle may traverse the vegetation or weeds without damage, whereas in the latter case injury to the animal may result. Thus, need exists for distinguishing one type of obstacle from another for safety reasons and effective vehicular control.

### SUMMARY OF THE INVENTION

A method and system for sensing an obstacle comprises transmitting an electromagnetic signal from a mobile machine to an object. A reflected electromagnetic signal is received from an observed point associated with an object to determine vector data (e.g., distance data and bearing data) between the object and a reference point associated with the mobile machine. An image patch is extracted from a region associated with the object. Each image patch comprises coordinates (e.g., three dimensional coordinates) associated with corresponding image data (e.g., pixels or voxels). If an object is present, image data may include at least one of object density data and object color data. Object density data is determined based on a statistical measure of variation of the vector data (e.g., distance data) associated with the object. Object color data based on the color of the object detected with compensation (e.g., brightness normalization). An object is classified or identified based on at least one of the determined object density and determined object color data.

### BRIEF DESCRIPTION OF THE DRAWINGS

FIG. 1 is a block diagram of an obstacle detection system in accordance with the invention.

FIG. 2 is flow chart of a method for detecting an obstacle.

FIG. 3 is a flow chart of another method for detecting an obstacle.

FIG. 4 is a flow chart for yet another method for detecting an obstacle.

FIG. 5 is a traversability map of a plan view of terrain in a generally horizontal plane ahead of a vehicle.

FIG. 6 is a first illustrative example of an obstacle classification map in a vertical plane ahead of a vehicle.

FIG. 7 is a second illustrative example of an obstacle classification map in a vertical plane ahead of the vehicle.

### DESCRIPTION OF THE PREFERRED EMBODIMENT

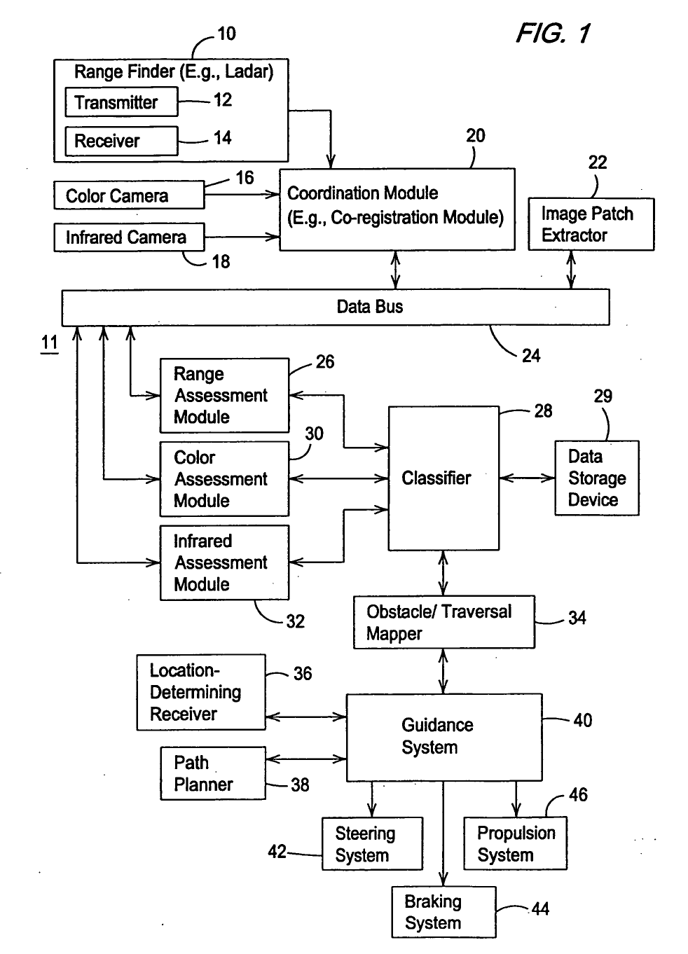

In FIG. 1, the obstacle detection system 11 comprises a range finder 10, a color camera 16, and an infrared camera 18 coupled to a coordination module 20. The coordination module 20, image patch extractor 22, range assessment module 26, color assessment module 30, and infrared assessment module 32 may communicate with one another via a databus 24. The range assessment module 26, the color assessment module 30, and the infrared assessment module 32 communicate with a classifier 28. In turn, the classifier 28 provides classification output data to an obstacle/traversal mapper 34.

The mapper 34, location-determining receiver 36 and a path planner 38 provide input data to a guidance system 40. The guidance system 40 provides output or control data for at least one of a steering system 42, a braking system 44, and a propulsion system 46 of a vehicle during operation of the vehicle.

In one embodiment, the range finder 10 comprises a laser range finder, which includes a transmitter 12 and a receiver 14. The transmitter 12 transmits an electromagnetic signal (e.g., visible light or infrared frequency signal) toward an object and the receiver 14 detects receivable reflections of the transmitted electromagnetic signal from the object. The receiver 14 may receive reflected signals from an observed point associated with the object to determine the multidimensional coordinates (e.g., Cartesian coordinates or polar coordinates) of the observed point with respect to the vehicle or a reference point on the vehicle or associated with a fixed ground coordinates. The range finder 10 measures the elapsed time from transmission of the electromagnetic signal (e.g., a pulse or identifiable coded signal) until reception to estimate the distance of between the object and the range finder 10 (mounted on the vehicle). The range finder 10 may determine the angle (e.g., a compound angle) of transmission or reception of the electromagnetic signal that is directed at the observed point on the object. The range finder 10 may provide distance data or coordinate data (e.g., three-dimensional coordinates) for one or more objects (or observed points associated therewith) in the field of view of the range finder 10.

A color camera 16 comprises a camera configured to operate in the visible light wavelength range. The color camera 16 may provide red data, green data, and blue data, intensity data, brightness data, hue data, contrast data, or other visual data on a scene around the vehicle. The foregoing data may be referred to as pixel data on a general basis.

The infrared camera 18 provides infrared image data of a scene around the vehicle. Infrared image data comprises infrared intensity versus position. An object may radiate, not radiate, or absorb infrared energy, which may provide different values of infrared image data that are perceptible by the infrared camera 18.

The coordination module 20 (e.g., co-registration module) receives coordinate data, pixel data, and infrared image data. The coordinate data, pixel data and infrared image data are associated, or spatially aligned, with each other so that the pixel data is associated with corresponding coordinate data and infrared image data is associated with corresponding coordinate data. The range finder (e.g., ladar) outputs range data points or vector data that indicates the three dimensional points of an object. The coordination module 20 may assign corresponding colors to the three-dimensional points of an object based upon color data provided by the color camera 16. The coordination module 20 may assign corresponding infra-red values (e.g., temperature values) based upon infrared data provided by the infrared camera 18. The three-dimensional points may be used to divide the spatial region about the vehicle into cells or image patches with reference to the real world coordinates or positions.

The image patch extractor 22 may be used to extract a desired patch of image data from a global representation of image data around the vehicle. The patch extractor is able to preserve the orientation of the patch with respect to the global representation or frame of reference for the patch. The image patch is defined with reference to determined multidimensional coordinates. In one example, the patch extractor may represent a patch in the region of one or more obstacles in a scene observable from a vehicle.

The range assessment module 26 may accept an input of the patch of image data and output statistical data thereon. In one embodiment, the range assessment module 26 may measure the variance in the distance of various distance data points or vector data points associated with an object or observed points thereon, to estimate the density of a material of an object. The density of a material refers to mass per unit volume. The density may be indicative of the compressibility, or compressive strength, of the material. Range statistics are effective for determining the consistency of the surface that caused the reflection of the electromagnetic signal.

In one embodiment, the range assessment module 26 estimates the spatial location data associated with the object by averaging the determined multidimensional coordinates (e.g., Cartesian coordinates) associated with various observed points on the object.

Standard deviation of the range or eigenvalues of the covariance matrix from the coordinates (e.g., three dimensional coordinates) in a small region can be used to discriminate between hard surfaces (e.g., a wall, vehicle or human) and soft penetrable surfaces (e.g., vegetation or weeds). A covariance matrix may be defined as a matrix wherein each entry is a product formed by multiplying the differences between each variant and its respective mean. An eigen value is a scalar that is associated with a nonzero vector such that the scalar multiplied by the nonzero vector equal the value of the vector under a given linear transformation. An eigen value may represent the amount of variance of total variants. Eigen values may be determine in accordance with the following equation: (Q−λI)V=0, where Q is a square covariance matrix, λ is the scalar eigen value, I is the identity matrix, wherein diagonal entries are one and all other entries of the matrix are set to zero, and V is the eigen vector.

In another embodiment, the range assessment module 26 may determine the three-dimensional location (e.g., in Cartesian coordinates or polar coordinates relative to the machine or another reference point) of an obstacle in the image data. Where laser, ladar (e.g., radar that uses lasers) or stereovision range measurements are available, the three dimensional location of each image patch can be estimated by averaging the coordinates of all of the three-dimensional image points that project into it. If no such three-dimensional image points are available, approximate locations of each path with respect to the vehicle can be obtained through a homography by assuming that the vehicle is traversing terrain that is locally flat.

The color assessment module 30 may accept an input of the patch of image data. Color data may be used for classification of one or more objects by the classifier 28. The color data outputted by the camera or stereo cameras are more effective when various image processing techniques are used (e.g., some form of brightness, intensity, lightness treatment or normalization is applied in order to reduce the influence of lighting conditions).

Several processing techniques may be employed to increase the robustness of color data. Under a first technique, brightness normalization is applied to reduce the influence of lighting conditions.

Under a second technique, the red, green, and blue information outputted by the camera can be represented by hue-saturation-value (HSV) color space with the brightness V disregarded. HSV defines a color space or model in terms of three components: hue, saturation and value. Hue is the color type (e.g., red, blue, green, yellow); saturation is the purity of the color, which is representative of the amount of gray in a color; value is representative of the brightness of color. Brightness is the amount of light that appears to be emitted from an object in accordance with an observer's visual perception. A fully saturated color is a vivid pure color, whereas an unsaturated color may have a grey appearance.

Under a third technique, the red, green and blue information outputted by the camera can be represented by hue-saturation-intensity (HIS) color space with the intensity component disregarded.

Under a fourth technique, normalized red-green-blue RGB data measurements may be used consistent with the RGB color space. For instance, R/(R+G+B), G/(R+G+B), and B/(R+G+B). The RGB color space is a model in which all colors may be represented by the additive properties of the primary colors, red, green, and blue. The RGB color space may be represented by a three dimensional cube in which red is the X axis, green is the Y axis, and blue is the Z axis. Different colors are represented within different points within the cube (e.g., white is located at 1,1,1, where X=1, Y=1, and Z=1).

Under a fifth technique, the CIE LUV space can be used in a similar fashion to the HSV space, ignoring the Lightness (L) component instead of the Value (V) component. CIE LUV color space refers to the International Commission on Illumination standard that is a device-independent representation of colors that are derived from the CIE XYZ space, where X, Y and Z components replace the red, green, and blue components. CIE LUV color space is supposed to be perceptually uniform, such that an incremental change in value corresponds to an expected perceptual difference over any part of the color space.

The infrared assessment module 32 may be used for one or more of the following tasks: (1) detecting humans and other large animals (e.g., for agricultural applications), and (2) discriminating between water and other flat surfaces, (3) and discriminating between vegetation and other types of materials. The infrared assessment module 32 determines whether the observed object emits an infrared radiation pattern of at least one of an intensity, size, and shape indicative of animal or human life. The infrared assessment module 32 may also determine whether the thermal image of a scene indicates the presence of a body of water.

The classifier 28 may output one or more of the following in the form of a map, a graphical representation, a tabular format, a database, a textual representation or another representation: classification of terrain cells in a horizontal plane within a work area as traversable or untraversable for a machine or vehicle, coordinates of cells in which obstacles are present within a horizontal plane within a work area, coordinates of terrain cells in which human obstacles or animal obstacles are present within a horizontal plane within a work area, coordinates of cells in which vegetation obstacles are present within the horizontal plane, coordinates of cells in which inanimate obstacles are present within the horizontal plane, classification of a vertical plane within a work area as traversable or untraversable for a machine or a vehicle, coordinates of cells in which obstacles are present within a vertical plane within a work area, coordinates of cells in which human obstacles or animal obstacles are present within a vertical plane within a work area, coordinates of cells in which vegetation obstacles lie within the vertical plane, and coordinates of cells in which inanimate obstacles are present within the vertical plane.

The classifier 28 may be associated with a data storage device 29 for storing reference color profiles, reference infrared profiles, reference infrared profiles, of animals, reference infrared profiles of human beings, reference color profiles of animals, reference color profiles of human beings, with or without clothing, reference color profiles of vegetation, plants, crops, and other data that is useful or necessary for classification of objects observed in image data. The reference color profiles of vegetation may include plants in various stages of their life cycles (e.g., colors of live plant tissue, colors of dead plant tissue, colors of dormant plant tissue.)

In one embodiment, the classifier 28 may classify an object as vegetation if the object density is less than a particular threshold and if the color data is indicative of a vegetation color (e.g., particular hue of green and a particular saturation of green in HSV color space.) The observed vegetation color may be compared to a library of reference color profiles of vegetation, such as different varieties, species and types of plant life in different stages of their life cycle (e.g., dormant, live, or dead) and health (e.g., health or diseased). The reference color profiles and the observed vegetation may be expressed in a comparable color spaces and corrected or normalized for device differences (e.g., camera lens and other optical features or image processing features peculiar to a device). Any of the processing techniques to compensate for lighting conditions including normalization or disregarding various components of intensity, brightness or lightness in various color spaces (e.g., HSV, RGB, HIS and CIE LUV) may be applied as previous described herein.

In one embodiment, the classifier 28 may classify an object as an animal if the object emits an infrared radiation pattern (e.g., a signature) indicative of the presence of an animal and if the color data is indicative of an animal color. The color is indicative of an animal color, wherein reference animal colors are stored for comparison to detected color data.

The mapper 34 feeds the guidance system 40 with obstacle classification data associated with corresponding obstacle location data. The obstacle classification data may be expressed in the form of traversability map in a generally horizontal or a vertical plane, or an obstacle map in a generally horizontal or vertical plane, or other classification data that is expressed in one or more planes with respect to terrain cells. A traversability map in the horizontal plane may be divided into cells, where each cell is indicative of whether it is traversable by a particular vehicle having vehicular constraints (e.g., ground clearance, turning radius, stability, resistance to tip-over, traction control, compensation for wheel slippage). An obstacle map in the vertical plane may be divided into multiple cells, where each cell is indicative of whether or not the respective cell contains a certain classification of an obstacle or does not contain a certain classification of obstacle. In one example, the classification comprises an obstacle selected from one or more of the following: an animal, a human being, tree, vine, bush, vegetation, grass, ground cover, a crop, a man-made obstacle, machine and tree-trunk.

The guidance system 40 is able to utilize vehicle location data, path planning data, obstacle location data, and obstacle classification data. The guidance system 40 may be assigned a set of rules to adhere to based on the vehicle location data, path planning data, obstacle location data, and obstacle classification data.

The guidance system 40 sends control data to at least one of the steering system 42, the braking system 44 and the propulsion system 46 to avoid obstacles or to avoid obstacles within certain classifications. The guidance system 40 may allow the vehicle to traverse “soft obstacles” such as grass, low lying vegetation or ground cover. However, for agricultural applications the “soft obstacles” may not represent valid paths where crop destruction is not desired. The guidance system 40 is configured to prevent the vehicle from striking hard obstacles, persons, animals, or where other safety or property damage concerns prevail.

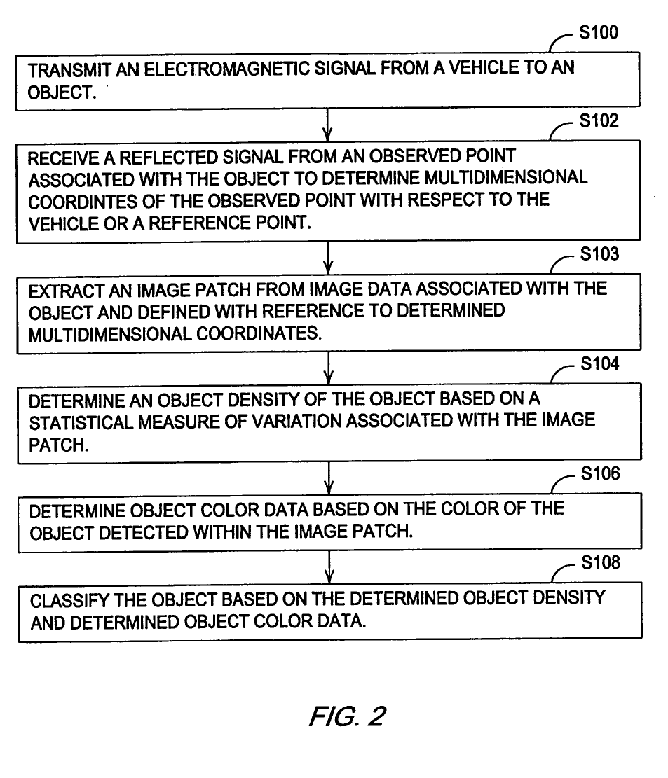

FIG. 2 illustrates a method for sensing an obstacle. The method of FIG. 2 begins in step S100.

In step S100, a range finder 10 transmits an electromagnetic signal from a mobile machine toward an object. For example, the range finder 10 transmits a signal toward one or more observed points on the object.

In step S102, the range finder 10 receives a reflected electromagnetic signal from the object to determine distance between an observed point on the object and the mobile machine, or three-dimensional coordinates associated with the observed point on the object. For example, a timer may determine the distance to the observed point by measuring the duration between the transmission (e.g., of a pulse or identifiable coded signal) of step S100 and the reception of step S102. The range finder 10 records the bearing or aim (e.g., angular displacement) of the transmitter during step S100 to facilitate determination of the spatial relationship of the observed point. By scanning or taking multiple measurements of one or more objects and using statistical processing, the multidimensional coordinates of one or more objects (e.g., obstacles) are determined. The multidimensional coordinates may be derived from vectors between the range finder and observed points on the obstacles. In one embodiment, the range finder 10 may estimate spatial location data associated with the object by averaging the spatial distances of the observed points.

In step S103, an image patch extractor 22 extracts an image patch from a region associated with the object. Each image patch comprises coordinates (e.g., three dimensional coordinates) associated with corresponding image data (e.g., pixels). If an object is present, image data may include at least one of object density data and object color data.

In step S104, a range assessment module 26 may determine object density data based on a statistical measure of variation associated with the image patch or multiple observed points associated with the object. For example, the statistical measure comprises a standard deviation of a range or eigen values of the covariance matrix for the multidimensional coordinates associated with an object.

In step S106, a color assessment module 30 may determine object color data based on the color of the object detected. For example, the color assessment module 30 may determine the object color detected by applying any of the processing techniques (as previously described herein) to compensate for lighting conditions including normalization or disregarding various components of intensity, brightness or lightness in various color spaces (e.g., HSV, RGB, HIS and CIE LUV). For RGB color space, the color data may comprise normalized red data, green data, and blue data. For HSV color space, the color data may comprise hue data and saturation data, with the value data disregarded.

In step S108, a classifier 28 classifies or identifies an object based on the determined object density and determined object color data. After completion of the method of FIG. 2, the classifier 28 may interface with a mapper 34, a vehicular controller, or a guidance module to control the path or guide the vehicle in a safe manner or in accordance with predetermined rules.

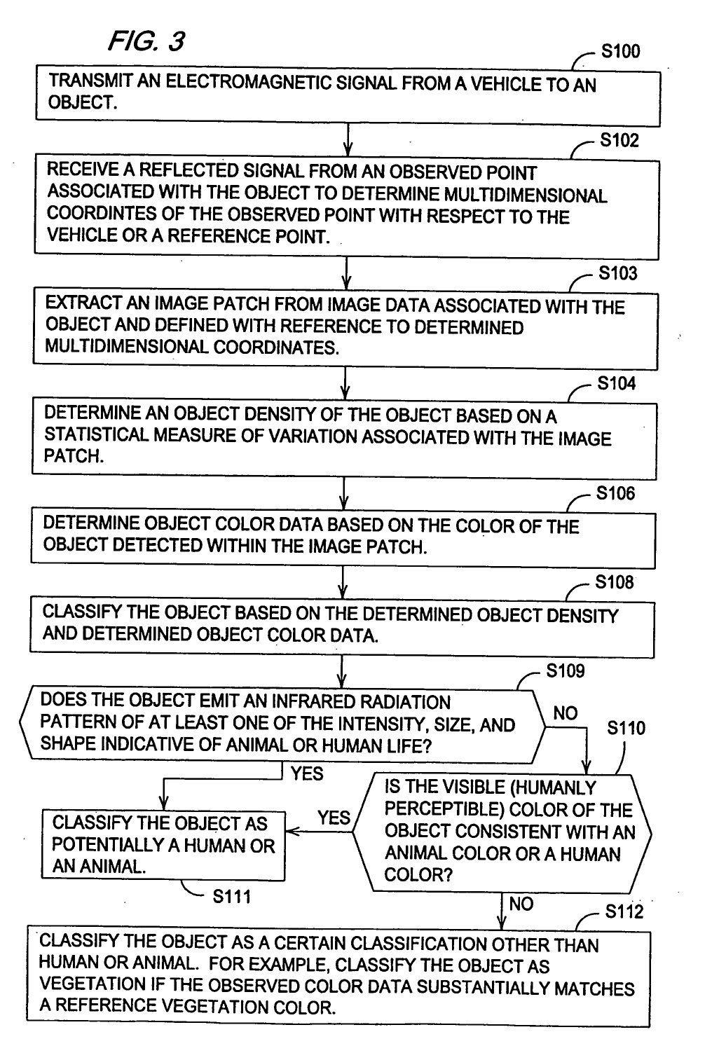

The method of FIG. 3 is similar to the method of FIG. 2 except the method of FIG. 3 further includes additional steps. Like reference numbers indicate like elements in FIG. 2 and FIG. 3. Step S109 occurs prior to, simultaneously with, or after step S108.

In step S109, an infrared assessment module 32 determines whether the object emits an infrared radiation pattern of at least one of an intensity, size, and shape indicative of animal or human life. If the object emits an infrared radiation pattern indicative of an animal or human life, than the method continues with step S111. However, if the infrared radiation pattern does not indicate an animal or human life, then the method continues with step S110.

In step S111, classifier 28 classifies the object as potentially human or an animal.

In step S110, the color assessment module 30 determines if the observed visible (humanly perceptible) color of the object is consistent with a reference animal color (e.g., fur color or pelt color) or consistent with a reference human color (e.g., skin tone, flesh color or clothing colors). The observed colors may be corrected for lighting conditions by applying any of the processing techniques, which were previously disclosed herein, including normalization (e.g., RGB normalization) or disregarding various components of intensity, brightness or lightness in various color spaces (e.g., HSV, RGB, HIS and CIE LUV). Reference animal colors and reference human colors may be stored in a library of colors in the data storage device 29. Further, these reference colors may be corrected for lighting conditions and use similar processing techniques to the observed colors. If the observed color is consistent with a reference animal color or a reference human color, the method continues with step S111. However, if the observed color is not consistent with any reference animal color or any reference human color (e.g., stored in the data storage device 29), the method continues with step S112.

In step S112, the classifier 28 classifies the object as a certain classification other than human or animal. For example, the classifier classifies the object as vegetation if the observed color data substantially matches a reference vegetation color. The observed color data and reference vegetation color may use the brightness compensation or other image processing techniques previously discussed in conjunction with the various color spaces (e.g., discarding the intensity, brightness or lightness values within various color spaces as previously described herein).

In step S111, a classifier 28 classifies an object in a certain classification in accordance with various alternative or cumulative techniques. Under a first technique, a classifier 28 classifies an object as vegetation if the object density is less than a particular threshold and if the color data is indicative of a vegetation color. The vegetation color may be selected from a library of reference vegetation color profiles of different types of live, dead, and dormant vegetation in the visible light spectrum.

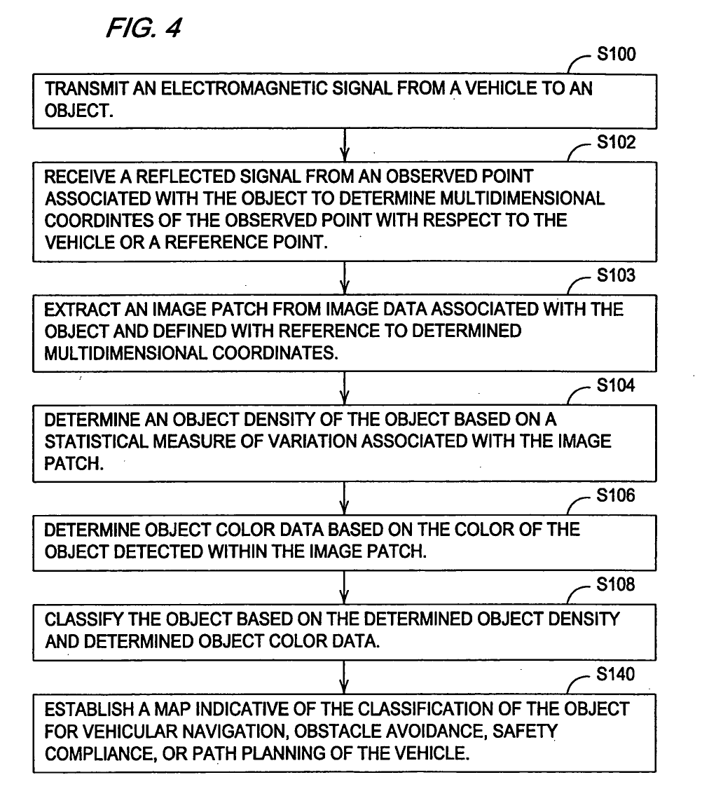

The method of FIG. 4 is similar to the method of FIG. 2 except the method of FIG. 4 includes additional step on establishing a map for vehicular navigation or path planning. Like reference numbers in FIG. 2 and FIG. 4 indicate like elements.

In step S140, a mapper 34 establishes a map for vehicular navigation, obstacle avoidance, safety compliance, path planning, a traversability map, an obstacle map, or the like. Step S140 may be accomplished in accordance with various procedures that may be applied alternatively or cumulatively. Under a first procedure, a traversability map is established in a horizontal plane associated with the vehicle. The map is divided into a plurality of cells where each cell is indicative of whether or not the respective cell is traversable. Under a second procedure, an obstacle map is established in a vertical plane associated with the vehicle, the map divided into a plurality of cells where each cell is indicative of whether or not the respective cell contains a certain classification of an obstacle or does not contain the certain classification of obstacle. The classification comprises an obstacle selected from the group consisting of an animal, a human being, vegetation, grass, groundcover, crop, man-made obstacle, machine, tree, bush, and a vine, and trunk.

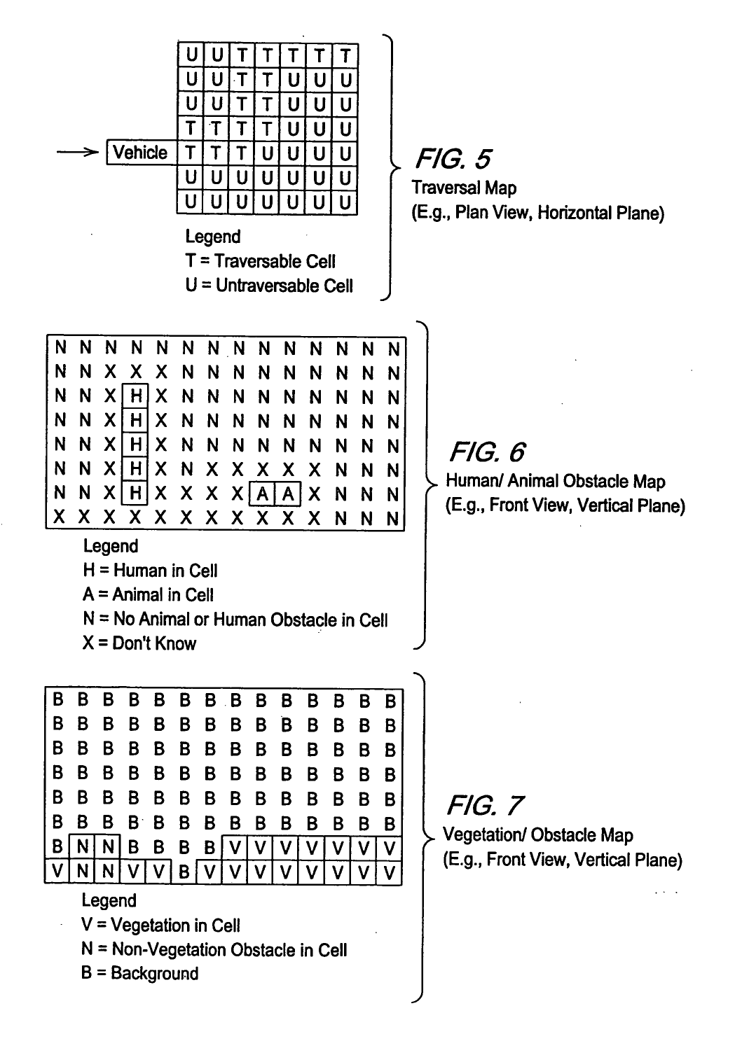

FIG. 5 illustrates an exemplary representation of a traversability map for a vehicle in a generally horizontal plane. The traversability map represents a work area for a vehicle or a region that is in front of the vehicle in the direction of travel of the vehicle. The work area or region may be divided into a number of cells (e.g., cells of equal dimensions). Although the cells are generally rectangular (e.g., square) as shown in FIG. 5, in other embodiments the cells may be hexagonal, interlocking or shaped in other ways. Each cell is associated with corresponding coordinates (e.g., two dimensional coordinates or GPS coordinates corrected with differential encoding) in a generally horizontal plane. Each cell is associated with a value representing whether that cell is traversable (e.g., predicted to be traversable) by the vehicle or not. As shown, the cells marked with the letter “T” are generally traversable given certain vehicle parameters and operating constraints, whereas other cells marked with the letter “U” are not.

FIG. 6 illustrates an exemplary representation of a human/animal obstacle map in a generally vertical plane in front of the vehicle. The work area or region may be divided into a number of cells or equal dimensions in the vertical plane. Although the cells are generally rectangular (e.g., square) as shown in FIG. 6, in other embodiments the cells may be hexagonal, interlocking or shaped in other ways. Each cell is associated with corresponding coordinates (e.g., two dimensional GPS coordinates with differential correction plus elevation above sea level or another reference level) in a generally vertical plane. Each cell is associated with a value representing one or more of the following: (1) human being is present in the cell; (2) a large animal is present in the cell; (3) the safety zone is present in a cell about or adjacent to the human being or animal; and (4) no human or animal is present in the cell. As illustrated in FIG. 6, a human is indicated as present in the cells labeled “H”; the animal is indicated as present in the cells marked “A”; “N” represents no human or animal present in a cell; and “X” represents a don't know state to take into account movement of a person or an animal, or any lag in processing time.

FIG. 7 illustrates a representation of a vegetation obstacle map in a generally vertical plane in front of the vehicle. This vertical plan may be considered as an image plane or, in other words, a virtual plane representing images viewed from the vehicle. The work area or region may be divided into a number of cells or equal dimensions in the vertical plane. Although the cells are generally rectangular (e.g., square) as shown in FIG. 7, in other embodiments the cells may be hexagonal, interlocking or shaped in other ways. Each cell is associated with corresponding coordinates (e.g., two dimensional coordinates plus elevation above ground) in a generally vertical plane. Each cell is associated with a value representing one or more of the following: (1) Vegetation is present in the cell; (2) Vegetation is not present in the cell; (3) Non-vegetation obstacle is present in the cell; and (4) Non-vegetation obstacle is not present in the cell. For example a vegetation color may comprise, visible green light for leaves, brown or grey for tree trunks, yellow for dead vegetation or grass. As shown in FIG. 7, the cells that contain vegetation are labeled with the letter “V”, the cells that contain a non-vegetation obstacle are marked with the “N” symbol, and other cells that do not qualify as “V” or “N” cells are marked with the letter ‘B”.

Many variations are possible with the present invention. For example, the present invention may utilize texture descriptors (sometimes call “texture features”) in addition to, or in place of, some of the various imaging, detection, and processing described herein. Texture is a property that can be applied to three dimensional surfaces in the everyday world, as well as to two-dimensional images. For example, a person can feel the texture of silk, wood or sandpaper with their hands, and a person can also recognize the visible or image texture of a zebra, a checker-board or sand in a picture.

In the image domain, texture can be described as that property of an image region that, when repeated, makes an observer consider the different repetitions as perceptually similar. For example, if one takes two different pictures of sand from the same distance, observers will generally recognize that the “pattern” or texture is the same, although the exact pixel values will be different.

Texture descriptors are usually, although not necessarily, derived from the statistics of small groups of pixels (such as, but not limited to, mean and variance). Texture features are typically extracted from grey-level images, within small neighborhoods, although color or other images, as well as larger neighborhoods, may also be used. Texture features may, for example, describe how the different shades of grey alternate (for example, how wide are the stripes in a picture of a zebra?), and how the range of pixel values can vary (for example, how bright are the white stripes of a zebra and how dark the black stripes of a zebra?), and the orientation of the stripe pattern (for example, are the stripes horizontal, vertical or at some other angle?)

Texture descriptors may, for example, be extracted for each image patch and analyzed for various content, such as the scale and orientation of the patterns present in the patch. These texture descriptors can then be combined with other features (such as those extracted from color, infrared, or range measurements) to classify image patches (e.g., obstacles or non-obstacles). Alternatively, texture descriptors may be used without combining them with other features.

One of the reasons texture information is useful for obstacle detection is that natural textures (such as grass, dirt, crops and sand) are generally different from textures corresponding to man-made object such as cars, buildings and fences. The ability to sense and process these differences in texture offers certain advantages, such as in classifying image patches.

In another embodiment of the invention, range measurements can be made using multiple images of a scene taken from slightly different view points, which is sometimes known as “stereo vision”. The process through which three dimensional range estimates can be obtained from multiple images of the same scene is known as “stereopsis”, and is also known as “stereo-vision” or “stereo”. This is the process through which human beings and many other two-eyed animals estimate the three dimensional structure of a scene. In general, when two images of the same scene are taken from slightly different locations, the images obtained are similar except for some pixel displacements. The amount by which different parts of the scene “shift” between the images is proportional to the three dimensional distance between the object and the camera(s). By knowing the relative locations from which the images where taken, one can estimate the three dimensional geometry of the scene through several well-known algorithms.

Obtaining three dimensional range estimates from stereo rather than laser has some advantages and some disadvantages. Some of the advantages include, stereo is generally less expensive because cameras tend to be less expensive than laser range finders. In addition, cameras are generally passive sensors (e.g., they do not emit electromagnetic waves) while lasers are active sensors. This can be important because, for example, some military applications restrict the use of active sensors which can be detected by the enemy. Some disadvantages of stereo include the range estimates obtained are generally less accurate then those obtained with laser range finders. This is especially important as the range increases, because the errors in stereo-vision grow quadratically with distance. In addition, stereo vision generally requires more computation, although real-time implementations have been demonstrated. Furthermore, stereo vision requires light to function, although infrared imagery and other non-visible light sensors may be used in low light (e.g., night time) applications.

Having described the preferred embodiment, it will become apparent that various modifications can be made without departing from the scope of the invention as defined in the accompanying claims.

1. A method for detecting an obstacle, the method comprising:
transmitting an electromagnetic signal from a vehicle to an object;
receiving a reflected signal from an observed point associated with the object to determine multidimensional coordinates of the observed point with respect to the vehicle or a reference point;
extracting an image patch from image data associated with the object and defined with reference to determined multidimensional coordinates;
determining an object density of the object based on a statistical measure of variation of observed points associated with the object;
determining observed color data based on an observed color of the object detected within the image patch; and
classifying the object based on the determined object density and determined object color data.

2. The method according to claim 1 wherein the determining of the observed color data comprises disregarding the brightness component, V, of the observed color data in a hue-saturation-value color space.

3. The method according to claim 1 wherein the determining of the observed color data comprises disregarding an intensity component, I, of the observed color data in a hue-saturation-intensity color space.

4. The method according to claim 1 wherein the determining of the observed color data comprises disregarding a lightness component, L, of the observed color data in a CIE LUV color space.

5. The method according to claim 1 wherein the determining of the observed color data comprises normalizing a red component, a green component, and blue component of the observed color data in red-green-blue color space.

6. The method according to claim 1 further comprising:
classifying an object as vegetation if the object density is less than a particular threshold and if the observed color data is indicative of a reference vegetation color.

7. The method according to claim 1 further comprising:
classifying an object as an animal if the object emits an infrared radiation pattern of an intensity, size and shape indicative of the presence of an animal.

8. The method according to claim 1 further comprising:
classifying the object as an animal if the object emits an infrared radiation pattern indicative of the presence of an animal and if the color data is indicative of an animal color, wherein reference animal colors are stored for comparison to the observed color data, the observed color data being compensated by discarding at least one of a brightness, lightness, or intensity component of a color space.

9. The method according to claim 1 further comprising:
classifying the object as a human being if the object emits an infrared radiation pattern indicative of the presence of a human being and if observed color data is indicative of flesh color or clothing colors.

10. The method according to claim 1 wherein the statistical measure comprises at least one of a standard deviation of a range or eigenvalues of a covariance matrix for the multidimensional coordinates associated with an object.

11. The method according to claim 1 further comprising:
estimating spatial location data associated with the object by averaging the determined multidimensional coordinates.

12. The method according to claim 1 further comprising:
establishing a traversability map in a horizontal plane associated with the vehicle, the map divided into a plurality of cells where each cell is indicative of whether or not the respective cell is traversable.

13. The method according to claim 1 further comprising:
establishing an obstacle map in a vertical plane associated with the vehicle, the map divided into a plurality of cells where each cell is indicative of whether or not the respective cell contains a certain classification of an obstacle or does not contain the certain classification of obstacle.

14. The method according to claim 13 wherein the classification comprises an obstacle selected from the group consisting of an animal, a human being, vegetation, grass, ground-cover, crop, man-made obstacle, machine, and tree trunk.

15. A system for sensing an obstacle, the system comprising:
a transmitter for transmitting an electromagnetic signal from a vehicle to an object;
a receiver for receiving a reflected signal from an observed point associated with the object to determine multidimensional coordinates of the observed point with respect to the vehicle or a reference point;
an image extractor for extracting an image patch in a region associated with the object and defined with reference to determined multidimensional coordinates;
a range assessment module for determining an object density of the object based on a statistical measure of variation associated with the image patch;
a color assessment module for determining object color data based on the color of the object detected with brightness normalization; and
a classifier for classifying the object based on the determined object density and determined object color data.

16. The system according to claim 15 wherein the color assessment module disregards a brightness component, V, of the observed color data in a hue-saturation-value color space.

17. The system according to claim 15 wherein the color assessment module disregards an intensity component, I, of the observed color data in a hue-saturation intensity color space.

18. The system according to claim 15 wherein the color assessment module disregards a lightness component, L, of the object color data in a CIE LUV color space.

19. The system according to claim 15 wherein the color assessment module normalizes a red component, a green component, and blue component of the object color data in red-green-blue color space.

20. The system according to claim 15 wherein the classifier classifies an object as vegetation if the object density is less than a particular threshold and if the color data is indicative of a vegetation color.

21. The system according to claim 15 wherein the infrared assessment module determines whether the object emits an infrared radiation pattern of at least one of an intensity, size, and shape indicative of animal or human life.

22. The system according to claim 15 wherein the classifier classifies an object as an animal if the object emits an infrared radiation pattern indicative of the presence of an animal.

23. The system according to claim 15 wherein the classifier classifies the object as an animal if the object emits an infrared radiation pattern indicative of the presence of an animal and if the color data is indicative of an animal color, wherein reference animal colors are stored for comparison to detected color data.

24. The system according to claim 15 wherein the classifier classifies the object as a human being if the object emits an infrared radiation pattern indicative of the presence of an animal and if the color data is indicative of flesh color or clothing colors, wherein reference human flesh colors, and reference clothing colors are stored for comparison to detected color data.

25. The system according to claim 15 wherein the statistical measure comprises a standard deviation of a range of eigenvalues of the covariance matrix for the multidimensional coordinates associated with an object.

26. The system according to claim 15 wherein the range assessment module estimates spatial location data associated with the object by averaging the determined multidimensional coordinates.

27. The system according to claim 15 further comprising a mapper for establishing a traversability map in a horizontal plane associated with the vehicle, the map divided into a plurality of cells where each cell is indicative of whether or not the respective cell is traversable.

28. The system according to claim 15 further comprising a mapper for establishing an obstacle map in a vertical plane associated with the vehicle, the map divided into a plurality of cells where each cell is indicative of whether or not the respective cell contains a certain classification of an obstacle or does not contain the certain classification of obstacle.

29. The system according to claim 28 wherein the classification comprises an obstacle selected from the group consisting of an animal, a human being, vegetation, grass, ground-cover, crop, man-made obstacle, machine, and tree trunk.
